(19) United States
(12) Patent Application Publication
(10) Pub. No.: US 2007/0033154 A1
(43) Pub. Date: Feb. 8, 2007

(54) System and method managing documents

(76) Inventors: Michael W. Trainum, Harrisonburg, VA (US); David R. Mikesell, Staunton, VA (US); Richard L. Mikesell, Staunton, VA (US); Benjamin M.W. Carpenter, Harrisonburg, VA (US); Nell-Marie L. Colman, Blacksburg, VA (US)

Correspondence Address: Michael Haynes, 1341 Huntersfield Close, Keswick, VA, 22947, US

(21) Appl. No.: 10/577,823

(22) PCT Filed: Oct. 29, 2004
(86) PCT No.: PCT/US04/36296

§ 371 Date: Apr. 28, 2006

Related U.S. Application Data
(60) Provisional application No. 60/515,566, filed on Oct. 29, 2003.

(51) Int. Cl. G06F 17/30

(52) U.S. Cl. 707/1

(57) ABSTRACT

Certain embodiments can comprise a system (1000), comprising a database (1380, 1900) storing a plurality of objects; and a computer-based document management module (1320, 1820) adapted to: create a source document (1400) comprising the plurality of objects (1420, 1440); and automatically and individually control a content, a plurality of content attributes, a usage permission, and a distribution permission of each of a plurality of objects in each of multiple documents derived from the source document.

### CROSS-REFERENCE TO RELATED APPLICATIONS

This application claims priority to, and incorporates by reference herein in its entirety, pending U.S. Provisional Patent Application Ser. No. 60/515,566 (Attorney Docket No. 1041-004), filed 29 Oct. 2003.

### BRIEF DESCRIPTION OF THE DRAWINGS

A wide variety of potential embodiments will be more readily understood through the following detailed description of certain exemplary embodiments, with reference to the accompanying drawings in which:

FIG. 1 is a block diagram of an exemplary embodiment of a system 1000;

FIG. 2 is a block diagram of an exemplary embodiment of an information device 2000; and

FIG. 3 is a flowchart of an exemplary embodiment of a method 3000.

### DEFINITIONS

When the following terms are used herein, the accompanying definitions apply:
activity—performance of a function.
adapted—made suitable for.
application—a set of computer-readable instructions.
Author—a user who creates a Version or an Edition.
automatic—performed via an information device in a manner essentially independent of influence or control by a user.
Book—used synonymously for the terms document, Version, and/or Edition. Also used to describe a primary document that can contain within its internal data structure an auxiliary document called a Study Guide containing additional instructional or educational content or reference material supportive of the content of the Book on a section-by-section basis but without intruding on the content or layout of the primary document or Book.
can—is capable of, in at least some embodiments.
comprised—included in; a part of.
comprises—includes, but is not limited to.
comprising—including but not limited to.
content—a substance of an object. For a text object, the content is the text of the object.
content attribute—a parameter and/or format of content. For a text object, an format of that text can be its font, font size, font style, color, character spacing, line spacing, justification, indent, and/or tabs, etc. A parameter of that text can be its positioning on a page, within a document, and/or within a structure and/or hierarchy of the document.
content creator information—data regarding an author and/or authorship, such as author name, contact information, first publication date, etc.
Content Object—an Object that contains content of any type including text, pictures, audio, and/or video, etc. The terms “Object” and “Content Object” are used interchangeably herein except where otherwise stated.
Content Objects are sometimes further described with reference to the type of content contained in the Content Object, e.g., “Text Object” or “Text Content Object.”
content type—a classification of a content of an object. Examples include text, picture, audio, and/or video, etc.
couplable—capable of being coupled.
couple(d)—to join, connect, and/or link two things together.
database—one or more structured sets of persistent data, usually associated with software to update and query the data. A simple database might be a single file containing many records, each of which is structured using the same set of fields.
Derivative Edition—an Edition that includes content derived from a Resource Edition. If content from a Derivative Edition is used to create a new Version or Edition, such Derivative Edition itself becomes the
Resource Edition for the new Version or Edition. Thus an Edition may be both a Derivative Edition and a Resource Edition.
derived document—a document having content whose origin can be traced to a source document, perhaps through one or more intermediate derived documents.
distribution permission—an identification of what sharing activities are allowed on a derivative document, such as open (no restrictions), non-commercial, and/or non-public, etc.
DNA—properties of a Shell and/or Edition relating to its security, credits, copyright, and/or genealogy as set in the Prime Edition. The application operates such that each Edition within a Shell contains the Shell DNA as well as DNA specific to that Edition (Edition DNA) and that each Derivative Edition contains the DNA of the Resource Edition from which it was derived as well as DNA specific to that Derivative Edition (if inserted by the creator of that Derivative Edition),
document—a physical and/or electronic collection of related data elements. If physical, a document comprises one or more sheets of paper and the related data elements printed thereon.
Edition—a document that has been Published.
haptic—both the human sense of kinesthetic movement and the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
Idea—information in the content area of a document that describes in a simple (minimal) way the information to be communicated in a following set of Content Objects. An “Idea Set” is a hierarchical and ordered collection of Ideas that forms the structure that supports the internal multi-leveled tree framework of the content area of a document with Ideas forming the internal “nodes” of the tree framework. Each Edition or Version can have an Idea Set containing one or more Ideas. Each Idea may be associated with one or more Content Objects, and a Content Object can be associated with a single Idea. Study guide pages also can be associated with Ideas.
individually control—to exercise authoritative or dominating influence over each identified aspect of each identified item.
information—data.
information device—any device capable of processing information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Handspring Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can include well-known components such as one or more network interfaces, one or more processors, one or more memories containing instructions (such as firmware and/or software), and/or one or more input/output (I/O) devices, one or more user interfaces, etc.
Input/Output (I/O) device—an input/output (I/O) device of an information device can be any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions adapted to perform a particular operation or function. Can be implemented as firmware and/or software.
language-independent search—for a set of items, each item having a content expressed in one of a plurality of predetermined languages, to examine each item in the set for a specified content regardless of in which of the predetermined languages that content is expressed.
memory device—any device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc. The memory device can be coupled to a processor and can store instructions adapted to be executed by the processor according to an embodiment disclosed herein.
module—a set of instructions for operating a processor.
network—a communicatively-coupled plurality of communication devices. Examples include wired and/or wireless communications networks, such as public, private, circuit-switched, packet-switched, connection-less, virtual, radio, telephone, POTS, non-POTS, PSTN, non-PSTN, cellular, cable, DSL, satellite, microwave, twisted pair, IEEE 802.03, Ethernet, token ring, local area, wide area, IP, Internet, intranet, wireless, Ultra Wide Band (UWB), Wi-Fi, BlueTooth, Airport, IEEE 802.11, IEEE 802.11a, IEEE 802.11b, IEEE 802.11g, X-10, and/or electrical power networks, etc., and/or any equivalents thereof. A network can have any architecture, including a direct connection, a local area network, a wide area network such as the public switched telephone network and/or the Internet, an extranet, and/or a combination thereof. A network can be a packet-switched, a circuit-switched, a connectionless, or connection-oriented network or interconnected networks, or any combination thereof. Moreover, a transmission media of a network can take any form, including wireline, optical, and/or wireless.
oject—a discrete item that can be selected and maneuvered, such as an onscreen graphic. In object-oriented programming, an instance of the data structure and behaviour defined by the object's class. Each object has its own values for the instance variables of its class and can respond to the methods defined by its class. For example, an object of the “Point” class might have instance variables “x” and “y” and might respond to the “plot” method by drawing a dot on the screen at those coordinates.
Owner—the user who has the right to control the future usage (e.g., read/write, read only, no access, and/or read/write with attribution, etc.) and distribution (e.g., open (no restrictions), non-commercial, and/or non-public, etc.) of an Edition and/or an Object within an Edition. The application treats the person who first inserts new content into an Object of a Version and/or Edition as the Owner of that Object and its content.
portion—a part of an item. Can be visually, physically, and/or virtually distinguishable and/or non-distinguishable.
primary document—a source document.
Prime Edition—the first Edition that is Published within a Shell.
processor—a hardware, firmware, and/or software machine and/or virtual machine comprising a set of machine-readable instructions adaptable to perform a specific task. A processor acts upon information by manipulating, analyzing, modifying, converting, transmitting the information to another processor or an information device, and/or routing the information to an output device. A processor can be a central processing unit, a local controller, a remote controller, parallel controllers, and/or distributed controllers, etc. The processor can be a general-purpose microcontroller, such the Pentium IV series of microprocessor manufactured by the Intel Corporation of Santa Clara, Calif. In another embodiment, the processor can be an Application Specific Integrated Circuit (ASIC) or a Field Programmable Gate Array (FPGA) that has been designed to implement in its hardware and/or firmware at least a part of an embodiment disclosed herein.
Publish—with respect to a document (i.e., a Version), a user taking an action using the application to “lock in” and/or “set” all attributes of a document (Version) and the Objects within the document such that the attributes may not be modified by a subsequent user of the document. The action by the user of locking in or setting the attributes of a document (Version) is called a “Publishing Event.”
Resource Edition—an Edition, some or all of the content of which is used to create a new Version or Edition. A Resource Edition may, but need not be, a Prime Edition.
Shell—a set of metadata that appear in the Prime Edition and that are used to specify and define certain attributes of a document or multiple documents that are created and designated by the user as being within that Shell. A Shell contains no Objects as such but contains only the Shell DNA, the Shell ID Number, and/or information about the user who originated the Shell (the Shell Originator). A Shell is originated by the user who Publishes a Prime Edition.
signal—detectable transmitted electrical and/or electro-magnetic energy that can be used to carry a message and/or information that comprises one or more letters, words, numbers, characters, and/or symbols, etc. The message and/or information in a signal can be, for example digitally encrypted via for example, public key, PGP, and/or triple-DES, etc. As another example, the signal can be broadcast via, for example, a spread-spectrum technology such as, for example a frequency hopping or a direct-sequence spread-spectrum system.
source document—an document that provides content that appears in derived documents, that content not derived from another document.
structure—a hierarchy and/or placement of objects in a document.
substantially—to a majority extent. More so than not. For the most part.
usage permission—an identification of what viewing and/or editing activities are allowed on a derivative document. Examples of usage permissions can include read/write, read only, no access, and/or read/write with attribution, etc.
user—a person interfacing with an information device.
user interface—any device for rendering information to a user and/or requesting information from the user. A user interface includes at least one of textual, graphical, audio, video, animation, and/or haptic elements.
Version—a document in the process of being produced by a user prior to such document being Published. When a document is Published it ceases to be a Version and becomes an Edition. A Version may be an originally produced document (a “Prime Version”) or it may contain content (e.g., Objects) copied or derived from a previously Published Edition in which case it is called a “Derivative Version”.

### DETAILED DESCRIPTION

Certain embodiments can comprise a system, comprising a database storing a plurality of objects; and a computer-based document management module adapted to: create a source document comprising the plurality of objects; and automatically and individually control a content, a plurality of content attributes, a usage permission, and a distribution permission of each of a plurality of objects in each of multiple documents derived from the source document.

Certain exemplary embodiments are referred to herein as Shellbook Publisher. Certain exemplary embodiments of Shellbook Publisher provide a software-based publishing tool that:
is built upon an object-oriented and/or object-relational database;
provides the ability to create a source document (a.k.a., primary edition of a “book”) having formatted textual, graphical, audio, and/or video content; and
provides the ability to control the content, format, structure, use, and/or distribution of each of multiple documents derived from that source document.

Certain exemplary embodiments of Shellbook Publisher can have particular utility for those who wish to provide a source document having content that is translatable to multiple alternative languages in derivative documents, yet control to what extent that content or its attributes can be changed in those derivative documents.

Certain embodiments of Shellbook Publisher can provide the following features:
The ability to define objects that comprise a source document from which derivative versions can be created, the objects of the derivative inheriting various attributes from the source document such as:
   object structure (e.g., hierarchy and/or placement of objects in the derivative);
   content type (e.g., text, picture, audio, and/or video, etc.);
   content;
   content format (e.g., for textual content: font, style, size, and/or color, etc.);
   content creator info (e.g., author, contact info, and/or first publication date, etc.);
   permissions for usage (e.g., read/write, read only, no access, and/or read/write with attribution, etc.); and/or
   permissions for distribution (e.g., open (no restrictions), non-commercial, and/or non-public, etc.).
II. The ability to perform a bi-directional comparison of a derivative and its source, even if the placement of an object in the derivative is different from the source.
III. The ability to search for a topic across all related documents (i.e., all the “books” in a “shell”, i.e., a source and its derivatives), regardless of differences in languages.
IV. The ability to store the content of an object only once in a database, so that multiple objects can point to the same content, thereby minimizing data duplication.
V. The ability to define a auxiliary document that is a subset of a primary document, the structure of the auxiliary document contained in and supported by the structure of the primary document, but the auxiliary document having different objects, so that as the structure of the primary document changes, the structure of the auxiliary document changes correspondingly. This integration allows for direct references between the primary document and the auxiliary document. If a derivative document is created from the primary, that derivative will include the structure of the auxiliary document as well. In one embodiment, the auxiliary document can be used as a “Study Guide” for a primary document that serves as a “Book”. In an exemplary embodiment, the Study Guide is organized into sections based upon the framework of the ideas in the Book and when the Book is reordered during editing, the Study Guide automatically reorders its content so it continues to match the Book.

What follows is a description of certain exemplary embodiments that implement one or more of the above-described features. No described requirement, rule, or aspect of these particular exemplary embodiments should be viewed as a requirement, rule, or aspect of all of the many potential embodiments, certain ones of which will become readily apparent to those skilled in this art from reading the above-recited overview of features and the below-recited detailed description of certain exemplary embodiments of those features.

Certain capitalized words or terms used in the following description have a particular meaning associated with them as described in definitions of such words or terms set out herein. Unless clearly specified otherwise, any “rules” described herein are merely descriptions of an operation of certain exemplary embodiments, and are not necessarily generally applicable.

This application incorporates by reference in its entirety U.S. Pat. No. 6,038,567, titled “Method and System for Propagating Object Properties in a Desktop Publishing Program”.

I. The ability to define objects that comprise a source document from which derivative versions can be created, the objects of the derivative inheriting various attributes from the source document such as:

Object structure (e.g., hierarchy and/or placement of objects in the derivative);
Content type (e.g., text, picture, audio, and/or video, etc.);
content;
Content format (e.g., for textual content: font, style, size, and/or color, etc.);
Content creator information (e.g., author, contact info, and/or first publication date, etc.);
Permissions for usage (e.g., read/write, read only, no access, and/or read/write with attribution, etc.); and/or
Permissions for distribution (e.g., open (no restrictions), non-commercial, and/or non-public, etc.).
   Introduction

Certain exemplary embodiments of this feature can provide a desktop publishing software program configured to allow for users to define a set of properties that identify the Owner of the content of a document or of an Object within the document, and govern the permission for usage and the permission for distribution for the document or for each Object that is contained in the document. To protect the Owner's rights, once the document is Published, all such defined properties are “locked” and the desktop publishing software program does not permit the modification of those properties. The desktop publishing software program is configured to propagate all Object properties to all derivative documents derived from the source document and to keep a record of the document from which the current document was derived.

What it Allows

Object Level Security as configured in the desktop publishing software program can allow the user to permanently protect his rights as the Author or Owner of the content by governing usage rights on each individual Content Object (picture, text, audio clip and video clip) in all documents created as derivatives from the original source document.

These rights include the Owner's ability to restrict the rights for anyone to use, modify or append the original contents or to append additional Author credits to or modify the original Author credits.

It allows permanent enforcement and protection of the Owner's original instructions on the legal use and the distribution of his Objects throughout multiple derivations of the original work. However, if permitted by the security properties, the desktop publishing software program is configured to allow the security properties to be modified to a more restrictive security setting in derivative works. It also allows the Owner of the content the ability to enter his contact information for each Object so that future users of the content contained in the Object may contact the Owner or his representative.

It also allows a formal Document Genealogy to be maintained within the document that allows the user to view from which document the current document was derived.

How is it Supported?

To enable Object Level Security and to enforce the security rules supported by the Object Level Security, the desktop publishing software program internally stores all data necessary within the application's database. Also, the desktop publishing software program contains the internal programmatic logic necessary to enforce the rules governing the security levels based upon the data entered by the Author/Owner of the Object.

Rules

Object Level Security

Object Level Security identifies and controls the ability of Authors of Derivative Versions to legally reuse a single Object contained within a Published Edition.

Object Level Security is applied to the contents of an Object. For example, Object Level Security may be applied to a photograph contained in a Picture Object such that if the picture is copied into a new Version, the security properties associated with that picture are copied into the new Object. Object level security also can be applied to metadata associated with that object. For example, if object metadata is specified, the security permissions on that object are applied to the metadata when the object is copied into a new version from the parent edition.

The application allows the Author of a new Version to define levels of security for text, picture, video, and audio Objects in both the Book section and the Study Guide Section of the document.

The application allows the user to define security properties for each and every Object in a Version. The exception to this is linked Text Content Objects. For security purposes, all Text Content Objects linked together in a single chain must be considered as one Text Content Object.

When the user views security properties, the application displays the same security properties regardless of which linked Text Content Object is currently active.

If a user changes security properties on a linked Text Content Object, the changes are applied to all Text Content Objects linked in that chain.

If a user sets security for an Object at the Object Level, this new level of security overrides the default Version Level security for that single Object only. Security properties set by the user for an Object constitute the Object Level Security for that Object.

If Object Level Security is not defined for an Object, the defined Edition Level security governs the security for that Object.

Subject to security restrictions, the application allows the user to add, change or remove Object Level Security at any time prior to the Publishing Event.

Once the Version is Published, all Object Level Security is frozen in the new Edition and may never be changed within the Published Edition.

Object Level Security (whether derived from Version Level or Object Level Security parameters) never restricts an Owner of an Object contained in a Published Edition from reusing his Object if he wishes to create a Derivative Version from such Published Edition.

When a new Derivative Version is created from a Resource Edition, all Object Level security properties must be copied from the Resource Edition to the Derivative Version.

Security Roles

The Shell Originator

The Shell Originator is the user that creates and Publishes a Prime Edition. A new Shell is created for every new Prime Edition and the Author of the Prime Edition is also the Shell Originator. Every Shell will have only one Originator.

The application stores the identity of the Shell Originator in an application database.

It is possible for a user to be both a Shell Originator and an Edition Author.

The Shell Originator may set certain Shell Level Security Permissions as the Shell Originator. Being the Shell Originator does not give that user overall Public Domain Rights to all Editions in that Shell as the security levels described below are applied only at the Edition and Object Levels.

The Edition Author

The Edition Author is the user that creates and Publishes a new Edition.

If the Edition is a Prime Edition, the Edition Author will also be the Shell Originator. If the Edition is not the Prime Edition, the Edition Author will not be the Shell Originator.

Every Edition will have one or more Authors. The application stores Author data (name, contact data, etc).

The Edition Author may set certain Edition Level Security permissions as the Edition Author.

The Edition Author is identified as the Author for the current Edition only. Being an Edition Author of the current Edition must not give that Author the status of Edition Author of derivative Editions which are spawned in the future from the current Edition.

The Object Owner

The Object Owner is the person that initially inserts an Object into a Version.

The application always grants the Object Owner ‘Public Domain’ rights to all of his own Objects that are inserted by him. That is, up until the version is published. Once the version is published, all objects are locked, even to the owner. The owner can then make a derivative and edit objects in the derivative according to ownership and security rules. This rule also applies to newly inserted Objects in derivative Versions where the Object Level Security applicable to other Objects grants more restrictive rights.

The Object Owner is not a visible property within the Object Properties window.

An Object may have only one Owner.

The application stores Object Owner data (name, contact information, etc.) for each Object.

The security levels described below apply only when the application does not identify the current user as the Object Owner.

The application allows the Object Owner to change the security properties of any of his Objects at any time up until the Publishing Event.

The designation as Object Owner is a permanent designation and must be propagated with all Objects that are copied into a new Derivative Version.

If an Object is deleted from a Version, all of the Object Owner information for that Object is also deleted.

The User

The user role is the role for which all of the security restrictions apply. An object/Shell/etc will only have one owner but may be viewed by any number of users.

Security Levels

Public Domain Option

If the ‘Public Domain’ option is chosen for an Edition or any specific Object, the creator permanently gives up all rights to the contents of that Edition or Object.

This security level allows users of the Edition to distribute, copy, modify, or build upon the Edition or Object at any time without anyone's permission.

If a Public Domain Edition is used as a resource for a new Derivative Version, the application does not move any documented credit attributes of the book or the Objects contained in the book into the new Derivative Version.

If a Public Domain Object is copied to a Derivative Version, the application does not move any documented credit attributes of the Object into the Derivative Version.

The application allows the Author of a Derivative Version to change any ‘Public Domain’ Security Level to any other security level at any time prior to the Publishing Event.

The ‘Public Domain Option’ at the Edition Level is the default Security Option when a new Shell is created.

By Attribution Option

If the ‘By Attribution’ option is chosen for the Edition or any Object contained in the Edition, the creator permanently gives up all rights to the contents of the book. However, all original credits at the Edition and/or Object Levels remain.

This security level allows users of an Edition to distribute, copy, modify, or build upon the book at any time without additional permission as long as the original credits (Author, dates, publishers, etc.) in the new Edition or Object remain as in the original.

If an Edition or Object is given a ‘By Attribution’ security level, that level is permanent and cannot be changed.

If a ‘By Attribution’ Edition is copied to a Derivative Version, the application moves all documented credit attributes of that Edition and the Objects contained in that Edition into the Derivative Version.

The application does not allow users of the Derivative Version the ability to change or delete any populated credit attributes moved into the Derivative Version that are protected by the ‘By Attribution’ security level.

The application allows users of the Derivative Version the ability to change or delete any unpopulated credit attributes moved into the Derivative Version, as they are not protected by the ‘By Attribution’ security level.

If a user changes the Version Level Security parameter, the application does not overwrite the security level of any Object with a ‘By Attribution’ security level.

If a ‘By Attribution’ Object is copied to a Derivative Version, the application moves all documented credit attributes of that Object into the Derivative Version.

The application does not allow users of the Derivative Version the ability to change or delete any Object credit attributes moved into the Derivative Version that are protected by the ‘By Attribution’ security level. However, the application does allow users of the Derivative Version the ability to insert text into any unpopulated Object credit attributes moved into the Derivative Version, as the ‘By Attribution’ security level does not protect unpopulated credit attributes.

No Derivative Works Option

If the ‘No Derivative Works’ option is chosen for the Edition or any Object contained within the Edition, the Author or Owner retains all rights to the contents of the Edition or Object.

This security level completely restricts the users of the Edition from copying, modifying, or building upon the Edition or Object at any time.

If an Edition or Object is given a ‘No Derivative Works’ security level, that level is permanent and cannot be changed.

A ‘No Derivative Works’ Edition is fully restricted and cannot be copied to a Derivative Version.

If a ‘No Derivative Works’ Object is contained within an Edition with ‘Public Domain’ or ‘By Attribution’ security level and that Edition is copied to a Derivative Version, that Object is not copied into the new Derivative Version.

If a user changes the Edition Level Security parameter, the application does not overwrite the security level of any Object with a ‘No Derivative Works’ security level.

Cannot Omit Option

The ‘Cannot Omit’ option is similar to the ‘By Attribution’ option in that for the chosen Edition or any specific Object, the creator enforces his right to require the user to include and retain the contents of the Edition and/or Objects and to retain the original credits.

This security level allows users of the Edition to distribute, copy, modify, or build upon the Edition at any time without anyone's permission as long as the original Objects and credits (author, dates, publishers, etc.) in the Edition or Object remain as in the original.

If an Edition or Object is given a ‘Cannot Omit’ security level, that level is permanent and cannot be changed.

This security level prohibits the users of the Edition from deleting any original property of the Edition or of the Object at any time.

This security level does, however allow creators of a Derivative Version to append additional Objects into the Version.

If a ‘Cannot Omit’ Resource Edition is copied to a Derivative Version, the application moves all Objects and documented credit attributes of the book and the Objects contained in the book into the Derivative Version.

The application does not allow users of the Derivative Version the ability to change or delete any property of any Object in the Derivative Version that is protected by the ‘Cannot Omit’ security level.

The application does not allow users of the Derivative Version the ability to change or delete any unpopulated credit attributes moved into the Derivative Version.

If a user changes the Edition Level Security parameter, the application does not override the security level of any Object with a ‘Cannot Omit’ security level.

Unrestricted/Noncommercial/Non-Public Parameter

The Unrestricted/Noncommercial/Non-Public parameters are Shell Level parameters that govern the printing of declamatory texts on all Editions Published under that Shell.

The Shell Originator may choose only one of the three options, as they are mutually exclusive.

If a user selects the ‘Unrestricted’ option, then no disclaimer is printed on the front and back covers of the Edition.

If the user selects the ‘Noncommercial’ option then the application prints the following disclaimer on the front and back covers of every copy of every Edition printed under that Shell:

This [document] has been created for non-commercial distribution only.

If the user selects the ‘Non-Public option then the application prints the following disclaimer on the front and back covers of every copy of every Edition printed under that Shell:

This [document] has been created for private, non-public distribution only.

Copyleft

The Copyleft requirement is satisfied within the rules governing the propagation and restrictions to changing the above security levels.

By Permission (License)

The ‘By Permission’ security level will allow the Author of a Derivative Version to use the Resource Edition (or an Object in the Resource Edition) only if the Resource Edition's Author or Object Owner has granted permission.

II. The ability to perform a bi-directional comparison of a derivative and its source, even if the placement of an object in the derivative is different from the source.

Introduction

Certain exemplary embodiments of this feature can provide a desktop publishing software program configured to formally enforce the document Publishing Event and during the Publishing Event to record and store the genealogy of the document (Document Genealogy; i.e. information regarding the source document from which a document is derived) in such a way that a user can reference the document created as a derivative of the original source document and perform a side-by side visual comparison of the derivative and its resource or any book related via the genealogy.

What it Allows

Document Genealogy storage allows for an Author or adaptor of a derivative work to perform side-by side visual comparisons of the content and layout of the derivative and its resource or any book related via the genealogy.

How is it Supported?

To enable side by side document comparisons, the application provides an alternative document view to the user. When the user selects this alternative document view (called ‘Pattern View’ in the application), the application identifies the resource document from the user's database and gathers the necessary content components from the source document to display. The application then displays the content of resources in a linear vertical fashion in parallel with the contents of the derivative document. The display of the two documents is governed by internal display rules which the desktop publishing software follows to reconcile the display content that has been modified or reordered in relation to the original source document.

Rules (See also General Terms)

General Rule

Pattern View supports the comparison of content only. The Outline Editor shows all of the Ideas and the Content Objects in the Version. Content displayed in the following non-content sections of a document do not display in Pattern View:

Front Cover

Inside Front Cover

Front Matter

Table of Contents

Glossary

Appendix

Back Matter

Inside Back Cover

Back Cover.

Pattern View shows the content of both documents in linear order using the Resource Edition's Object mapping as the main determinant of Object order.

Pattern View functionality is only available when a user is editing a Version, either an original Version for a Prime Edition or Derivative Version. Pattern View is not available when the user is viewing a Published Edition.

The application will not allow users to perform any editing of content in Pattern View unless permitted by security parameters in the resource.

Pattern View supports a standard multi-document interface allowing the user to toggle between all currently open books one at a time.

In Pattern View, the application shows the current Version on the right half of the Pattern View workspace and the current Version's Resource (or any book related via the genealogy) on the left half of the Pattern View Workspace in what essentially are two inline columnar displays.

Upon initial entry into Pattern View, the application determines if the Object currently in focus is in the Content Area of the Version. If the current Object is contained in the Version Layout Workspace the application selects the first Content Object of the first Idea as the Content Object to display. If the current Object is in the Content area of the book or if the first Content Object has been selected then the application determines Object order for the Idea to be displayed in accordance with the rules listed below.

If there is no equivalent Idea in the Resource Edition (for example, the current Idea is a New Idea added to the Derivative Version or the current Version is a Prime Version without a Resource) the application displays a blank space in the corresponding area of the Resource Column.

When Pattern View is invoked, the application must show all of the Objects associated with the current Idea and the Objects must be ordered in accordance with the Object ordering rules.

In Pattern View all Objects must be shown actual size as scaled by the zoom level.

In Pattern View all Ideas and Objects are displayed in the column left justified. If the program's user interface is localized to a right-to-left language (e.g. Arabic), the justification can be right justified.

All content Objects displayed in the Pattern View are immovable and not resizable.

If text extends beyond the borders of the content Object, then elevator bars attached to the content Object allow the user to access the additional text

The application always keeps the vertical display of both columns in synch. If the list of Objects is too long to be displayed in either column within the Pattern View Workspace, the application presents a single vertical scroll bar to the user. The scroll bar is used to scroll both columns at the same time. When the user uses the scroll bar, both columns scroll equally.

The application allows the user to navigate through the Ideas either through the Pattern View Idea Navigation or the Outline Editor

As Pattern View is an inline display of a full Idea, the application provides the user a method to navigate through the Book by Idea. In addition, navigation is allowed to other books in the shell, so that the current derivative can be compared with other books in that shell. The application allows the user to navigate by either the Ideas in the Resource or by the Ideas in the Derivative

When a user selects a different Idea, the application refreshes the display and shows only the Objects associated with the newly selected Idea in accordance with the layout rules.

Pattern View Content Type Display Rules:

Text and Picture Content Objects must be shown actual size and display their content.

The application displays icons representing Audio and Video Content Object in the same manner in which they are displayed in Layout View, (the application's general use editing screen) and allows users to initiate the playing of an Audio or Video file in Pattern View in the same manner as in Layout View.

There are no special rules relating to Objects which are repeated in a document (Repeated Objects). Each occurrence of a Repeated Object must be shown in order as a regular (non-repeated) Object.

The Three Object Types for Determining the Positioning and Ordering of the Objects:

An Object that appears in both the Resource and the Derivative—a Common Object. A Common Object need not be in the same Idea as the Resource Object—it can be under any Idea in the Derivative Version.

An Object that appears in the Resource but is not in the Derivative—a Resource Object. This can happen when an Object is not copied over to the Derivative because of security settings or the Object has been copied over to the Derivative but has been deleted.

An Object that appears in the Derivative but is not in the Resource—a New Object. This is when a new Object has been inserted into the Derivative.

Pattern View Object Positioning and Ordering Determination Rules

When the Pattern View is initially displayed or the user has selected a new Idea to display within Pattern View, before the application can display the Objects, the application must determine their order.

Objects are ordered based primarily on their order within the Resource Edition.

Objects on lower numbered pages come before Objects on higher numbered pages (the Z axis).

For Objects on the same page, the application uses the upper left hand corner coordinate of the Object to determine position.

For Objects on the same page, Objects above other Objects come first—the Y axis takes precedence for Objects on the same page.

For Objects sharing the same Y coordinate, the application determines order based upon the X axis.

For LTR (i.e., left-to-right language (e.g. English)) languages, Objects to the left come before Objects to the right.

For RTL languages, Objects to the right come before Objects to the left.

If one or more layered Objects share the same X and Y axis coordinates, the Object on the topmost layer appears first, with the Objects in subsequent layers being displayed next in order.

Rules for Determining Pattern View Display Order:

The application first determines if any New Objects have been inserted into the Derivative Version.

All New Objects that appear in the Derivative Version before the first Common Object appear first in order in Pattern View. These Objects appear first in the Derivative Column.

A blank space the same size as the New Object is displayed in the Resource Column as a place holder.

Next, the application refers to the mapping of the Objects in the Resource Edition and uses that mapping as the main determinate of further Object order.

Every Common Object is displayed in both the Resource Column and the Derivative Column.

Every Resource Object is displayed in the Resource Column only. The application displays a blank place holder space in the Derivative Column.

For every Common Object found, the application checks in the Derivative Version to determine if there are any New Objects immediately following a Common Object.

If the application finds one or more New Objects immediately following the Common Object, the application includes the New Objects directly below the Common Object in the Derivative Column in Pattern View.

The application includes all New Objects until the application finds another Common Object or until it finds the end of the Derivative Version. For each New Object found under this rule, the application inserts a blank place holder space in the Resource Column.

The application checks for linked Text Content Objects. If an Object in the Resource Edition is a linked Text Content Object and the Object is the first Text Content Object in the chain, the application displays that Text Content Object in the Resource Column and displays all Text Content Objects in the chain in order, immediately after the first one.

If an Object in the Resource Edition is a linked Text Content Object, but is not the first Text Content Object in the chain, the application ignores it.

In the Derivative Version Column, if by reference to a Text Content Object in the Resource Edition, the application is required to display the first Text Content Object in a linked chain in the Derivative Column, the application displays the Text Content Object and displays all Text Content Objects in the chain in order, immediately after the first one.

If the set of linked Text Content Objects displayed in the two columns is not of equal length, the application inserts a placeholder Object in the shorter column to make the two sets of linked Text Content Objects of equal length and maintain the visual synchronization between the two columns.

Resource Objects are displayed in the Resource Column in the order that they appear in Layout View as determined by the rules above.

For each Resource Object, the application inserts a blank place holder space the same size as the Resource Object in the Derivative Column so that side by side synchronization is maintained.

Pattern View Functionality Rules

The application allows the user to select Objects in Pattern View, but the application does not allow the user to insert, delete or resize any Object in Pattern View

The application may allow text editing; but it will only allow text editing in Pattern View if the Pattern View Text Editing Property has been set in the Resource Edition to allow text editing. Although Text Editing in Pattern View may be allowed, the application considers the selected text Object's security properties before fully allowing text editing on a specific Object. If Text Editing is allowed, only text within the Version (right column) may be edited and the application enables all text editing menu options and their corresponding Toolbar buttons while the editable text Object is selected.

Text-editing permission only allows the user to reformat, add, change or delete text within existing Text Content Objects. Text editing permission does not allow the user to add new Text Content Objects or to resize or link any existing Text Content Objects

If a user enters text into a Text Content Object such that the box becomes too small to display all of the text, the application displays a vertical scroll bar on the text box to allow the user to view or continue entering all of the text. If this situation occurs with linked Text Content Objects, linked Text Content Object rules apply and the vertical scroll bar only appears on the last linked Text Content Object.

The application allows users to initiate the playing of an Audio or Video file in Pattern View.

The application allows users to access, view, and change any Derivative Object's Properties. This can be governed by the object's ownership and security restrictions.

III. The ability to search for a topic across all related documents (i.e., all the “books” in a “shell”, or a source and its derivatives), regardless of differences in languages.

Introduction

Certain exemplary embodiments of this feature can provide a desktop publishing software program configured to store contents in such a way that the Prime Edition and all derivatives of a Prime Edition are logically contained in a ‘Shell’. Once an Edition in the Shell is referenced, the program can identify all other Editions in the Shell.

What it Allows

Shell referential functionality in combination with Edition Level properties storage allows for language independent database search functionality. It allows the desktop publishing software program to return search results in multiple languages even though the search parameters have been entered in a single language. It also allows the search results to be returned in a language different from the language of the parameters entered for the search.

How is it Supported?

To enable multi-language searches, the desktop publishing software program supports the input and storage of property data at the Edition Level like the Edition title, the topic or topics of the Edition, description or synopsis, etc. In addition, all Editions within the same Shell will share many (if not all) of the same values within the Edition's common properties. Because Edition properties are stored at the Edition Level, an Edition can store all of its properties in the same language as the Edition's content. Within these properties as with the Edition's content, it is possible and feasible that the content of these properties of all Editions within a given Shell will differ only by language. So a single Shell containing many Editions may contain as many different language descriptions of a topic or any other Edition property as there are Editions in the Shell.

When a user initiates a search in the desktop publishing software program, unlike all other search functions, the program automatically performs a two-level search before returning the search results to the user.

The first search is a standard database query that returns values based upon the user's query. The values from which this first part of the search is based can be in any language the user deems appropriate. It the search does not return any values, the program informs the user that no data can be returned. However, if the search returns data, rather than the application immediately displaying the data to the user, the application performs a second query.

The second query uses the Shell relationship supported in the desktop publishing software program to identify all other Editions in the Shell of the Edition or Editions returned in the original query. In this way, the application can return search values to the user in a language different from what was originally entered.

The functionality can be combined with other search criteria supported by the desktop publishing software program to return only Editions in the required language even though the search was initiated in a different language.

Rules (see also General Terms)

Shell Rules

A Shell may contain one or many Editions/Versions; however an Edition/Version will only belong to a single Shell.

All Editions/Versions in the same Shell contain the same Shell DNA.

A new Shell cannot be created by itself. It must have a supporting Version/Edition underneath it.

A new Shell is created as part of creating a new Prime Version.

Whenever a new Version is created from a Resource Edition, all of the Shell DNA from that Resource Edition is copied into the new Derivative Version.

Shell DNA is only editable prior to the Publishing the first Edition in the Shell.

Once the Prime Edition has been Published the Shell DNA may never be changed.

Search Rules

The application supports multiple languages; therefore it is required that the search criteria also support multiple language searches, whereby a user may find, for example, an Edition in Spanish on the topic for which he is searching even though the user does not know the Spanish word for the topic and enters the English word.

For all searches, the application returns all Editions that have the same Shell ID Number as the Edition originally found whenever the application finds a match on any of the search criteria that the user has entered.

The exception to this rule is when a user enters a language in the search criteria.

In this case a final filter must be performed before the list is returned and only the Editions in the language chosen are returned. This supports the scenario where a user is looking for an Edition in Spanish for the topic he is searching, even though the user does not know the Spanish word for the topic and enters the English topic word.

IV. The ability to store the content of an object only once in a database, so that multiple objects can point to the same content, thereby minimizing data duplication.

Introduction

Certain exemplary embodiments of this feature can provide a desktop publishing software program configured to store contents in such a way that all identical content that may be propagated across multiple distinct documents is stored only once; thereby minimizing database size and reducing storage requirements.

What it Allows

Content storage and referencing allows the contents of an Object to be stored in the software program's database only once regardless of the number of times the content is displayed within a single document or throughout multiple documents stored on the local system. The software supports this function while also insuring that when content is modified, only one instance of the content is modified and all other instances of the content are left in their original unmodified states.

How is it Supported?

To enable content storage, the desktop publishing software program physically splits the storage of content from the storage of the Container Object in which that content is displayed. The database contains a table that links an identifier of the content (the Content Identifier) to an identifier of the Container Object (the Container Object Identifier). Each document constructed using the desktop publishing software program is built by the insertion and ordering of a number of Container Objects. Each Container Object contains an internal reference to the one set of content that it contains and displays. Multiple Container Objects may each reference the same or different content in the database. As a result, multiple Container Objects may reference and display the same content.

Rules (See General Terms)

The desktop publishing software program supports the following Object content storage rules, which may be applied to all types of content (text, still digital images, digital video, and digital audio) uniformly:
1. A Content Object stores all properties regarding the placement, size and shape of the Content Object as well as a reference to the content that it displays to the user.
2. Content can only be displayed to a user through a Content Object.
3. A Content Object can only reference one set of content.
4. Content can be referenced by one or many Content Objects.
5. Content Objects can exist without referencing content but content cannot exist in the database without being referenced by a Content Object.
6. Content referenced by a Content Object will be displayed in the application within the boundaries of the Content Object
7. If content that is referenced by only one Content Object is modified, the desktop publishing software program will apply the modifications directly to that content.
8. If content that is referenced by multiple Content Objects is modified, the desktop publishing software program creates a copy of the content to which the modifications are applied.
9. When changes are saved, the desktop publishing software program saves the modified content and the reference to the content in the selected Content Object is changed to refer to the modified content. The references in the other Content Objects are not modified and continue to point to the original content.
10. If a Content Object that is unique in its reference to a set of content is deleted, then the content that it is referencing is also deleted.
11. If a Content Object that references content referred to by other Content Objects is deleted then only the Content Object is deleted. The content is untouched so that it may still be referenced by the other Content. Objects
12. Relocating a Content Object within the document does not affect the Content Object's reference to the content it contains.
   V. The ability to define a document that is auxiliary to a primary document, the auxiliary document having the same structure as the primary document, but different objects, so that as the structure of the primary document changes, the structure of the auxiliary document changes correspondingly. If a derivative document is created from the primary, that derivative will include a derivative of the auxiliary document as well. In one embodiment, the auxiliary document can be used as a “Study Guide” for a primary document that serves as a “Book”.
   Intro

Certain exemplary embodiments of this feature can provide a desktop publishing software program configured to support an auxiliary document (here sometimes called a “Study Guide”) of unlimited size and content within the internal data structure of a primary document (here sometimes called a “Book”) where the each section of the auxiliary document relates directly to a specific section of the primary document.

What it Allows

The auxiliary document allows additional instructional or educational content or reference material to be available without intruding on the content or layout of the primary document or Book. It also allows the inclusion of an exam or testing material or Study Guide to be available with the Book. Because every section of the auxiliary document is directly related to a specific section of the primary document, the desktop publishing software program allows synchronized user navigation between the two documents within the common section. It also allows independent user navigation within the primary and the auxiliary documents. During the editing process, it allows for the automatic reordering of the sections of the auxiliary document due to the reordering of the sections in the primary document. When a derivative of the Book is created, the program applies all rules for creating a derivative to both the Book and the Study Guide equally.

How is it Supported?

Structurally, this functionality is supported by configuring the program and the program database to support two separate and distinct, but parallel, content object trees rooted on a single higher level ‘section Object’ (called an ‘Idea’ and/or a ‘Focal Point’) Each tree supports the same types of Objects and there is no limit to the number of Objects that can exist on either side of the tree. Whenever a user inserts a new Idea into the primary document, the database creates a new reference from the auxiliary document to the new Idea.

Navigation is supported by first allowing the user to view either the primary document or the auxiliary document individually or both documents simultaneously within the program. Within any view, the highest level navigation is by the section and the program allows the user to navigate either document by section. When navigating the primary document, the program always keeps the display of the auxiliary document section in synch with the primary document by section. Derivative works are supported by applying the same rules for creating a derivative to both the primary and auxiliary documents.

General Rules

All documents created by the desktop publishing software program will contain a primary content document and an auxiliary content document.

Both the primary document and the auxiliary document are organized by sections.

A section may contain zero, one or many Content Objects.

A Content Object may exist in either the primary document or the auxiliary document, but not both.

A Content Object in the primary document may reference content also referenced in the auxiliary document and vice versa.

The primary document controls the structure of the Book such that when a user inserts another section into the primary document, the application automatically creates a corresponding section in the auxiliary document.

It is not possible to add a new section in the auxiliary document directly.

When a user navigates through the primary document by section, the program keeps the display of the auxiliary document in synch with the display or the primary document.

Navigating through the auxiliary document does not keep the display of the primary document in synch.

If a section is added to the primary document, a new section is added into the auxiliary document maintaining the same ordering as in the primary document.

If a section is deleted from the primary document, that section and all content within that section in the auxiliary document are also deleted.

If a section is reordered within the primary document, that section and all content in the auxiliary document are also reordered within the sections of the auxiliary document.

When a derivative Version is created, the application applies all rules governing the creation of a derivative Version and the migration of content Objects to both the primary and auxiliary documents of the Version equally.

All content manipulation functionality available to the user in the primary document is available to the user in the auxiliary document.

The auxiliary document supports all content types supported in the primary document.

Shell Rules

A Shell may contain one or many Editions/Versions; however an Edition/Version will only belong to a single Shell.

All Editions/Versions in the same Shell contain the same Shell information.

A new Shell cannot be created by itself It must have a supporting Version/Edition underneath it.

A Shell is created as part of creating a new Prime Version.

Whenever a new Version is created from a Resource Edition, all of the Shell DNA from that Resource Edition is copied into the new Derivative Version.

Shell DNA is only editable prior to Publishing the first, or Prime, Edition in the Shell. Once the Prime Edition has been Published the Shell DNA may never be changed.

Edition Rules

Many Editions can exist under a single Shell but an Edition can belong to only one Shell.

There is a difference between an Edition and Edition Level DNA.

An Edition exists only as a Published work. An unpublished Edition is known as a Version.

Edition Level DNA is the metadata describing the lineage and credits of the Edition.

Not all Published Editions are Resource Editions, but all Resource Editions are Published Editions.

Example of terms—When a new Shell is created, the application must create the minimal data of a Shell and an Edition before the user begins to add content to the unpublished Version that he will be working on. Before or during the Publishing Event, the Shell and Edition DNA data must be completed. Once that first Edition of that Shell is Published it becomes the Prime Edition. If the Prime Edition is classified as Resource Edition, then all Derivative Editions will contain the Prime Edition's Shell Level and Edition Level DNA.

Version Rules

Many Versions can be created from a single Resource Edition. But a Version can only have a single parent Edition.

All Versions of an Edition share the same Shell and Edition Level DNA.

When the Derivative Version is created from a Resource Edition, the application must copy all of the Resource Edition's DNA and contents into the new Derivative Version subject to copyright restrictions.

When the user creates an Exported Version, at the time of export, the application must copy all of the Source Version's Shell and Edition Level DNA and contents into the new Exported Version.

A single Version may only be Published once as a single Edition; but every Version derived from an Edition may be Published. All related Editions Published in this way will contain the same DNA.

A user must be able to fully edit the contents of a version (subject to Object and Edition Level security restrictions copied from the Resource) up until the time of the Publishing Event.

When a Version is Published and becomes an Edition, the contents are frozen and may not be changed except by creating a new Derivative Version from the Published Edition.

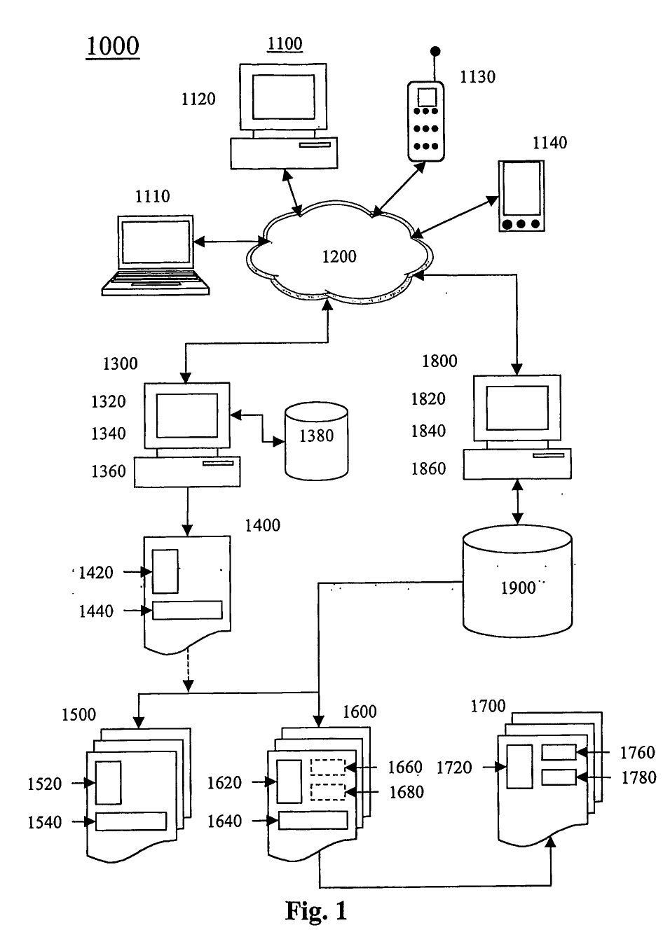

FIG. 1 is a block diagram of an exemplary embodiment of a system 1000, which can comprise one or more information devices 1100, such as information devices 1110, 1120, 1130, 1140. Each such information device 1100 can be coupled via a network 1200 to an Author's information device 1300.

Author's information device 1300 can comprise a document management module 1320, accessible to an Author via a user interface 1340. Author's information device 1300 can also comprise a database management system 1360, via which information stored in one or more databases, such as database 1380 and/or database 1900, and related to documents created and/or managed with document management module 1320, can be managed.

Document management module 1320 can allow an Author to create a source document 1400, comprising a plurality of objects, 1420, 1440. The Author can specify and/or define any number of characteristics, such as a content, a plurality of content attributes, a usage permission, and/or a distribution permission, of each of the plurality of objects 1420, 1440. Content attributes can include content formatting information, content type information, document structure information, content creator information, etc. The plurality of objects 1420, 1440, can comprise a text object, graphical object, animated object, haptic object, audio object, and/or video object.

By virtue of the specification and/or definition of a source document, its objects, and/or characteristics of those objects, an Author can provide for the automatic and/or individual control of each of those documents, objects, and/or characteristics in each of multiple documents derived from the source document.

The characteristics of any objects 1420, 1440 of a source document 1400 can be propagated to any derivative documents 1500, 1600, 1700 derived from source document 1400. Some characteristics can be modified in a derivative document, some can not. For example, characteristics of object 1420 of source document 1400 can propagate to derivative documents 1500, 1600, 1700. Characteristics of object 1440 can propagate to some of derivative documents 1500, 1600. That is, some objects and/or their characteristics can be modified and/or deleted in a derivative document. Thus, an Author of a first derivative document 1600 can add objects 1660, 1680, and delete object 1640 from any documents 1700 derived from that first derivative document 1600.

Information related to source documents, their objects, and/or characteristics of those objects can be stored in a database 1380. Any database can be local to Author information device and/or remote from Author information device. For example, information related to source documents, their objects, and/or characteristics of those objects can be stored in one or more databases 1900, which can be accessible via one or more database servers 1800, each of which can comprise a document management module 1820, a user interface 1840, and/or a database management system 1860. In certain exemplary embodiments, information related to source documents, their objects, and/or characteristics of those objects can be stored only once in a given database, and/or only once in all databases.

Document management module 1320 and/or 1820 can allow an Author to publish a source document 1400. Via document management module 1320 and/or 1820 one or more derivative documents can be derived from a source document, such that the source document's objects and/or their characteristics are propagated to the derivative documents. Via document management module 1320 and/or 1820, modification of an object and/or its characteristics can be prevented in a derivative document.

Via document management module 1320 and/or 1820, an identity of a source document can be determined from a derivative document and/or one or more of its objects. Via document management module 1320 and/or 1820, a bi-directional comparison can be performed between a source document and a document derived from the source document, and/or between two derivative documents derived from the same source.

Via document management module 1320 and/or 1820, database 1380 and/or 1900 can be searched independently of language. That is, a query can be entered in any of a plurality of predetermined languages and the database searched for a match, such as a semantic match, in any of the plurality of languages.

Via document management module 1320 and/or 1820, an auxiliary document can be generated from the source document, the auxiliary document reflecting at least a portion of a structure of the source document. The structure of the auxiliary document can differ from that of the source document. The content of the auxiliary document can differ from that of the source document.

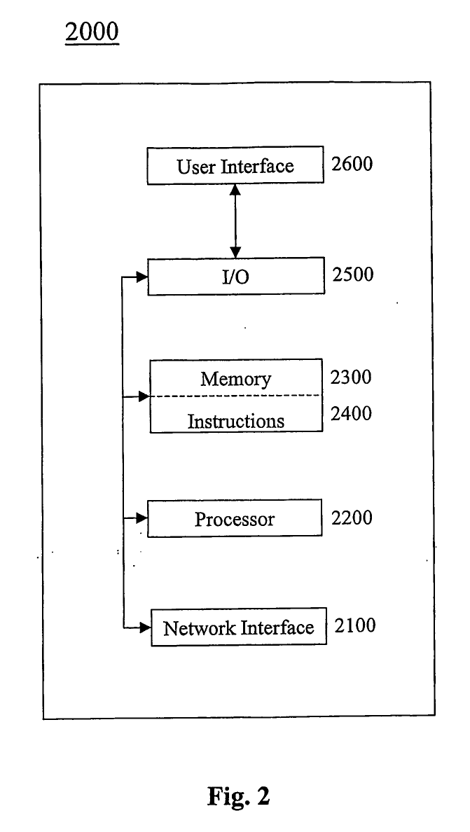

FIG. 2 is a block diagram of an exemplary embodiment of an information device 2000, which in certain operative embodiments can comprise, for example, any information device 1100 and/or server 1800 of FIG. 1. Information device 2000 can comprise any of numerous well-known components, such as for example, one or more network interfaces 2100, one or more processors 2200, one or more memories 2300 containing instructions 2400, one or more input/output (I/O) devices 2500, and/or one or more user interfaces 2600 coupled to I/O device 7500, etc.

In certain exemplary embodiments, via one or more user interfaces 2600, such as a graphical user interface, a user can author and/or access a source and/or derivative document.

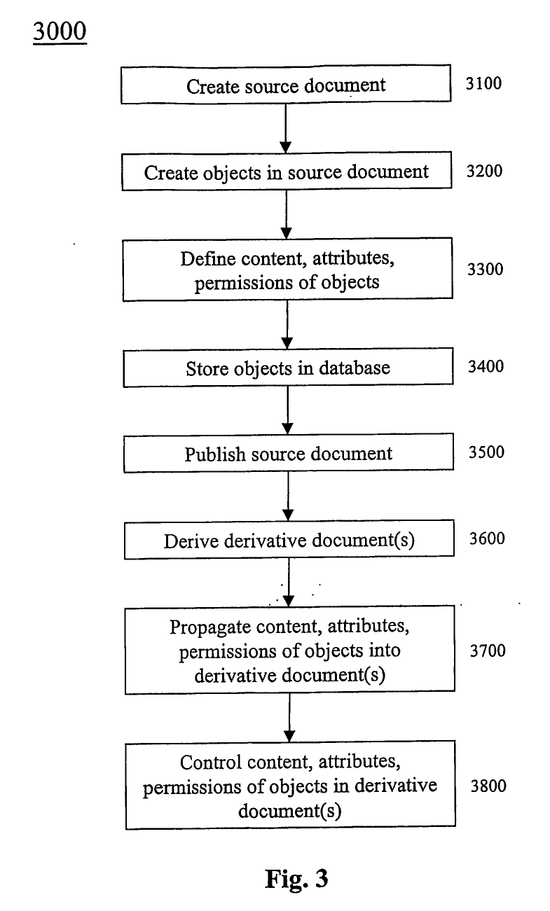

FIG. 3 is a flowchart of an exemplary embodiment of a method 3000. At activity 3100, an Author can create a source document. At activity 3200, the Author can create objects in the source document. At activity 3300, the Author can define characteristics of the objects, such as a content, attributes, and/or permissions. At activity 3400, information regarding the source document, objects, and characteristics can be stored in a database. At activity 3500, the source document can be published. At activity 3600, one or more derivative documents can be derived from the source document. At activity 3700, objects and/or their characteristics can be propagated to the derivative document(s). At activity 3800, the propagated objects and/or their characteristics can be controlled.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

What is claimed is:

1. A system, comprising:
a database storing a plurality of objects; and
a computer-based document management module adapted to:
create a source document comprising the plurality of objects; and
automatically and individually control a content, a plurality of content attributes, a usage permission, and a distribution permission of each of a plurality of objects in each of multiple documents derived from the source document.

2. The system of claim 1, wherein said document management module is further adapted to define a content, a plurality of content attributes, a usage permission, and a distribution permission of each of the plurality of objects of the source document.

3. The system of claim 1, wherein said document management module is further adapted to prevent modification of a content, a plurality of content attributes, a usage permission, and a distribution permission of each of the plurality of objects of the source document.

4. The system of claim 1, wherein said document management module is further adapted to publish the source document.

5. The system of claim 1, wherein said document management module is further adapted to generate a derived document from the source document.

6. The system of claim 1, wherein said document management module is further adapted to derive each of the multiple documents from the source document.

7. The system of claim 1, wherein said document management module is further adapted to propagate the content, plurality of content attributes, usage permission, and distribution permission of the source document to each of the multiple documents derived from the source document.

8. The system of claim 1, wherein said document management module is further adapted to prevent modification of the content, plurality of content attributes, usage permission, and distribution permission in each of the multiple documents derived from the source document.

9. The system of claim 1, wherein said document management module is further adapted to determine an identity of the source document from each of the multiple documents derived from the source document.

10. The system of claim 1, wherein said document management module is further adapted to perform a bi-directional comparison of the source document and a derivative document derived from the source document.

11. The system of claim 1, wherein said document management module is further adapted to perform a bi-directional comparison of a first derivative document derived from the source document and a second derivative document derived from the source document.

12. The system of claim 1, wherein said document management module is further adapted to language-independently search the database.

13. The system of claim 1, wherein said document management module is further adapted to generate an auxiliary document from the source document, the auxiliary document reflecting at least a portion of a structure of the source document, at least a portion of a content of the auxiliary document differing from a content of the source document.

14. The system of claim 1, wherein each of the plurality of objects is stored only once in said database.

15. The system of claim 1, wherein the plurality of content attributes comprises content formatting information.

16. The system of claim 1, wherein the plurality of content attributes comprises content type information.

17. The system of claim 1, wherein the plurality of content attributes comprises document structure information.

18. The system of claim 1, wherein the plurality of content attributes comprises content creator information.

19. The system of claim 1, wherein the plurality of objects comprises a text object.

20. The system of claim 1, wherein the plurality of objects comprises a graphical object.

21. The system of claim 1 wherein the plurality of objects comprises an audio object.

22. The system of claim 1, wherein the plurality of objects comprises a video object.

23. A method, comprising a plurality of activities comprising:
via a computer-based document management module:
creating a source document comprising a plurality of objects, each of said plurality of objects stored in a database; and
automatically and individually controlling a content, a plurality of content attributes, a usage permission, and a distribution permission of each of a plurality of objects in each of multiple documents derived from the source document.

24. The method of claim 23, further comprising defining a content, a plurality of content attributes, a usage permission, and a distribution permission of each of the plurality of objects of the source document.

25. The method of claim 23, further comprising preventing modification of a content, a plurality of content attributes, a usage permission, and a distribution permission of each of the plurality of objects of the source document.

26. The method of claim 23, further comprising publishing the source document.

27. The method of claim 23, further comprising generating a derived document from the source document.

28. The method of claim 23, further comprising deriving each of the multiple documents from the source document.

29. The method of claim 23, further comprising propagating the content, plurality of content attributes, usage permission, and distribution permission of the source document to each of the multiple documents derived from the source document.

30. The method of claim 23, further comprising preventing modification of the content, plurality of content attributes, usage permission, and distribution permission in each of the multiple documents derived from the source document.

31. The method of claim 23, further comprising determining an identity of the source document from each of the multiple documents derived from the source document.

32. The method of claim 23, further comprising performing a bi-directional comparison of the source document and a derivative document derived from the source document.

33. The method of claim 23, further comprising searching across the source document and each document derived from the source document.

34. The method of claim 23, further comprising generating an auxiliary document from the source document, the auxiliary document reflecting at least a portion of a structure of the source document, at least a portion of a content of the auxiliary document differing from a content of the source document.

35. The method of claim 23, wherein each of the plurality of objects is stored only once in said database.

36. A machine readable medium storing instructions for activities comprising:
creating a source document comprising a plurality of objects, each of said plurality of objects stored in a database; and
automatically and individually controlling a content, a plurality of content attributes, a usage permission, and a distribution permission of each of a plurality of objects in each of multiple documents derived from the source document.
